(19) United States
(12) Patent Application Publication
(10) Pub. No.: US 2026/0213912 A1
(43) Pub. Date: Jul. 23, 2026

(54) METHODS AND APPARATUSES FOR COMMUNICATION IN CARRIER AGGREGATION SCENARIO

(71) Applicant: LENOVO (BEIJING) LIMITED, Beijing (CN)

(72) Inventors: Ruixiang MA, Beijing (CN); Yuantao ZHANG, Beijing (CN); Hongmei LIU, Beijing (CN); Zhi YAN, Beijing (CN); Haiming WANG, Beijing (CN)

(21) Appl. No.: 19/138,902

(22) PCT Filed: Dec. 14, 2022
(86) PCT No.: PCT/CN2022/139004

§ 371 Date: Jun. 13, 2025

(51) Int. Cl. H04L 5/14; H04L 5/00

(52) U.S. Cl. CPC H04L 5/1438; H04L 5/0044

(57) ABSTRACT

Embodiments of the present disclosure relate to methods and apparatuses for communication in a carrier aggregation (CA) scenario. According to some embodiments of the disclosure, a UE may: determine, for a symbol, a reference cell among multiple cells, wherein a symbol format of the symbol on at least one cell of the multiple cells is subband non-overlapping full duplex (SBFD); and determine how to receive or transmit information in the symbol on the reference cell and another cell among the multiple cells according to transmission or reception types of the reference cell and the another cell.

### TECHNICAL FIELD

Embodiments of the present disclosure generally relate to wireless communication technology, and more particularly to communication in a carrier aggregation (CA) scenario.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long-term evolution (LTE) systems, LTE-advanced (LTE-A) systems, or LTE-A Pro systems, and fifth generation (5G) systems, which may also be referred to as new radio (NR) systems.

In a wireless communication system, a base station (BS) and a user equipment (UE) may communicate via downlink (DL) channels and uplink (UL) channels. CA technology may be used in a wireless communication system to, for example, increase data rates. For example, CA technology may refer to aggregating spectrum resources (e.g., carriers or cells) from the same frequency band or different frequency bands. In a CA scenario, multiple cells may be configured for a UE and DL or UL channels may be carried on one or more of the multiple cells.

The industry desires technologies for facilitating communication (e.g., transmission and reception) in a CA scenario.

### SUMMARY

Some embodiments of the present disclosure provide a user equipment (UE). The UE may include a transceiver, and a processor coupled to the transceiver. The processor may be configured to: determine, for a symbol, a reference cell among multiple cells, wherein a symbol format of the symbol on at least one cell of the multiple cells is subband non-overlapping full duplex (SBFD); and determine how to receive or transmit information in the symbol on the reference cell and another cell among the multiple cells, according to transmission or reception types of the reference cell and the another cell.

In some embodiments of the present disclosure, a symbol format of the symbol on the reference cell is not SBFD. In some embodiments of the present disclosure, a symbol format(s) of the symbol on at least one cell of the multiple cells is not SBFD.

Some embodiments of the present disclosure provide a base station (BS). The BS may include a transceiver, and a processor coupled to the transceiver. The processor may be configured to: determine, for a symbol, a reference cell among multiple cells configured for a user equipment (UE), wherein a symbol format of the symbol on at least one cell of the multiple cells is subband non-overlapping full duplex (SBFD); and determine how to receive information from or transmit information to the UE in the symbol on the reference cell and another cell among the multiple cells according to transmission or reception types of the reference cell and the another cell.

In some embodiments of the present disclosure, the reference cell is from a set of cells of the multiple cells, wherein a symbol format of the symbol on each cell of the set of cells is not SBFD.

In some embodiments, a symbol format of the symbol on a cell of the set of cells is: downlink (DL) but not SBFD or uplink (UL) as indicated by a higher layer configuration; UL, if the symbol is indicated as flexible but not SBFD, and a UL reception is configured to be performed in the symbol; UL, if the symbol is indicated as flexible and SBFD, a UL reception is configured to be performed in the symbol, and a DL transmission is not configured to be performed in the symbol; DL, if the symbol is indicated as flexible but not SBFD, and a DL transmission is configured to be performed in the symbol; or DL, if the symbol is indicated as flexible and SBFD, a DL transmission is configured to be performed in the symbol, and a UL reception is not configured to be performed in the symbol.

In some embodiments, a symbol format(s) of the symbol on at least one cell of the multiple cells is not SBFD.

In some embodiments of the present disclosure, a symbol format of the symbol on the reference cell is not SBFD.

In some embodiments, the symbol format of the symbol on the reference cell is: downlink (DL) but not SBFD or uplink (UL) as indicated by a higher layer configuration; UL, if the symbol is indicated as flexible but not SBFD, and a UL reception is configured to be performed in the symbol; UL, if the symbol is indicated as flexible and SBFD, a UL reception is configured to be performed in the symbol, and a DL transmission is not configured to be performed in the symbol; DL, if the symbol is indicated as flexible but not SBFD, and a DL transmission is configured to be performed in the symbol; or DL, if the symbol is indicated as flexible and SBFD, a DL transmission is configured to be performed in the symbol, and a UL reception is not configured to be performed in the symbol.

In some embodiments, a symbol format(s) of the symbol on at least one cell of the multiple cells is not SBFD.

In some embodiments of the present disclosure, the symbol format of the symbol on the reference cell of the multiple cells is: SBFD, if the symbol is indicated as SBFD by a higher layer configuration; UL, if the symbol is indicated as SBFD by a higher layer configuration; UL, if the symbol is indicated as flexible and SBFD, a UL reception is configured to be performed in the symbol, and a DL transmission is not configured to be performed in the symbol; or DL, if the symbol is indicated as flexible and SBFD, and a DL transmission is configured to be performed in the symbol, and a UL reception is not configured to be performed in the symbol.

In some embodiments of the present disclosure, the processor is further configured to prohibit at least one of the following in the case that the another cell operates in the same frequency band as the reference cell: indicating the symbol format of the symbol as downlink (DL) on the reference cell and as SBFD on the another cell; or indicating the symbol format of the symbol as uplink (UL) on the reference cell and as SBFD on the another cell.

In some embodiments of the present disclosure, determining how to receive information from or transmit information to the UE on the reference cell and another cell includes: assuming the symbol as flexible, when the symbol is indicated as SBFD on the another cell and as uplink (UL) or downlink (DL) on the reference cell, or when the symbol is indicated as SBFD on the another cell and one of: a UL reception is configured to be performed in the symbol on the reference cell and a DL transmission is configured to be performed in the symbol on the reference cell; assuming the symbol as DL, when the symbol is indicated as SBFD on the another cell and as DL on the reference cell, or when the symbol is indicated as SBFD on the another cell and a DL transmission is configured to be performed in the symbol on the reference cell; assuming a DL or UL frequency domain region in the symbol on the another cell as a flexible frequency domain region, when the symbol is indicated as SBFD on the another cell and as UL or DL on the reference cell, or when the symbol is indicated as SBFD on the another cell and one of: a UL reception is configured to be performed in the symbol on the reference cell and a DL transmission is configured to be performed in the symbol on the reference cell; or not transmitting configured data to the UE in the symbol or in a DL frequency domain region in the symbol on the another cell, or not receiving configured data from the UE in the symbol or in a UL frequency domain region in the symbol on the another cell, when the symbol is indicated as SBFD on the another cell and as UL or DL on the reference cell, or when the symbol is indicated as SBFD on the another cell and one of: a UL reception is configured to be performed in the symbol on the reference cell and a DL transmission is configured to be performed in the symbol on the reference cell.

In some embodiments of the present disclosure, the processor is further configured to perform at least one of the following before determining how to receive information from or transmit information to the UE on the reference cell and another cell: determining the transmission or reception type of the symbol on the reference cell; or determining the transmission or reception type of the symbol on the another cell.

In some embodiments, determining the transmission or reception type of the symbol on the reference cell includes determining the transmission or reception type of the symbol on the reference cell as being indicated as uplink (UL) in the symbol on the reference cell in the case that: the symbol is indicated as SBFD on the reference cell; or the symbol is indicated as SBFD on the reference cell and neither a UL reception nor a downlink (DL) reception is configured or scheduled to be performed in the symbol on the reference cell.

In some embodiments, determining the transmission or reception type of the symbol on the another cell includes determining the transmission or reception type of the symbol on the another cell as being indicated as SBFD in the symbol on the another cell in the case that: the symbol is indicated as SBFD on the another cell; or the symbol is indicated as SBFD on the another cell and neither a UL reception nor a downlink (DL) reception is configured or scheduled to be performed in the symbol on the another cell.

In some embodiments of the present disclosure, the symbol format of a symbol being SBFD includes at least one of the following: the symbol being indicated as downlink with an uplink (UL) frequency region or a UL subband; the symbol being indicated as flexible with a UL frequency region or a UL subband; or the symbol being indicated as flexible and a downlink (DL) reception and a UL reception being configured to be performed in the symbol simultaneously.

Some embodiments of the present disclosure provide a method performed by a UE. The method may include: determining, for a symbol, a reference cell among multiple cells, wherein a symbol format of the symbol on at least one cell of the multiple cells is subband non-overlapping full duplex (SBFD); and determining how to receive or transmit information in the symbol on the reference cell and another cell among the multiple cells according to transmission or reception types of the reference cell and the another cell.

Some embodiments of the present disclosure provide a method performed by a BS. The method may include: determining, for a symbol, a reference cell among multiple cells configured for a UE, wherein a symbol format of the symbol on at least one cell of the multiple cells is subband non-overlapping full duplex (SBFD); and determining how to receive information from or transmit information to the UE in the symbol on the reference cell and another cell among the multiple cells according to transmission or reception types of the reference cell and the another cell.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2A and 2B illustrate exemplary slot formats in accordance with some embodiments of the present disclosure;

FIG. 3 illustrates an exemplary slot format in a CA scenario in accordance with some embodiments of the present disclosure;

FIG. 4 illustrates an exemplary subband full duplex scheme in accordance with some embodiments of the present disclosure;

FIG. 5 illustrates a flow chart of an exemplary procedure for determining how to transmit or receive on a symbol in accordance with some embodiments of the present disclosure;

FIG. 6 illustrates an exemplary schematic diagram for determining a reference cell in accordance with some embodiments of the present disclosure;

FIGS. 7 and 8 illustrate exemplary schematic diagrams for determining whether to receive or transmit information on a symbol in accordance with some embodiments of the present disclosure;

FIG. 9 illustrates a flow chart of an exemplary procedure for determining how to transmit or receive on a symbol in accordance with some embodiments of the present disclosure; and

FIG. 10 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

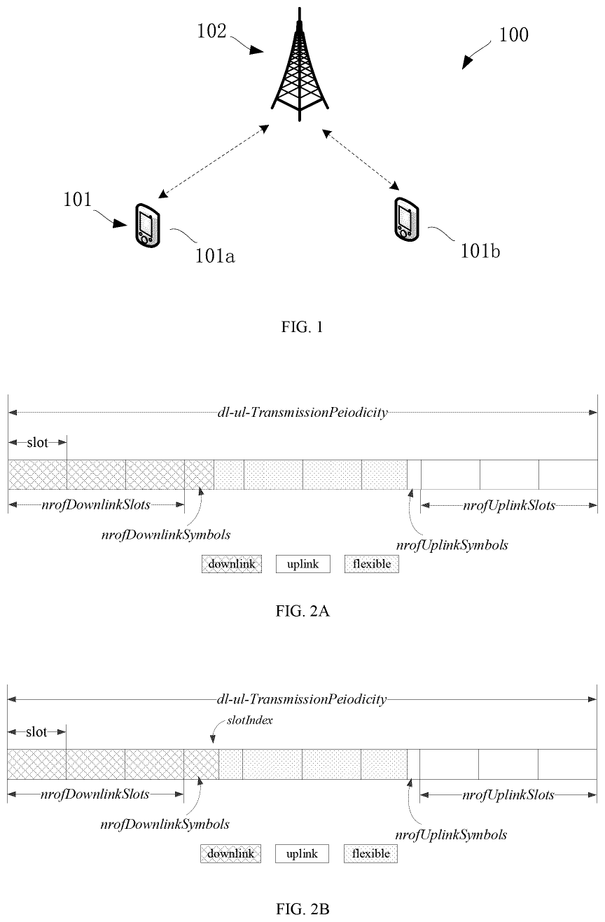

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographical region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In some embodiments of the present disclosure, a time division duplex (TDD) slot format may include at least one of a DL symbol, a UL symbol and a flexible symbol. “Flexible” means that a UE cannot make any assumptions on the transmission direction. In some embodiments, a downlink control signal (e.g., a physical downlink control channel (PDCCH)) may be monitored in flexible symbols. Or if a scheduling message is found, a UE may perform transmission or reception in the flexible symbols accordingly. The flexible symbols can also serve as a guard period for a UE to switch from DL reception to UL transmission, or vice versa.

In some embodiments of the present disclosure, a slot format can be configured or determined by a higher layer configuration (e.g., a cell common UL/DL configuration such as tdd-UL-DL-ConfigCommon as specified in 3GPP specifications, or a UE specific UL/DL configuration such as tdd-UL-DL-ConfigDedicated as specified in 3GPP specifications).

For example, a cell common UL/DL configuration (e.g., tdd-UL-DL-ConfigCommon) may be provided to a UE through system information. The cell common UL/DL configuration may include configurations of a transmission pattern. For example, a cell common UL/DL configuration may indicate one or more of the following:
a slot configuration period of P msec (e.g., by dl-ul-transmission-periodicity)
a number of downlink slots dₛₗₒₜₛ (e.g., by nrofDownlinkSlots)
a number of downlink symbols d_{sym} (e.g., by nrofDownlinkSymbols)
a number of uplink slots uₛₗₒₜₛ (e.g., by nrofUplinkSlots)
a number of uplink symbols u_{sym} (e.g., by nrofUplinkSymbols).

It is assumed that the slot configuration period of P msec includes S slots. The transmission pattern can be determined as: among the S slots, a first dₛₗₒₜₛ slots includes only downlink symbols and a last uₛₗₒₜₛ includes only uplink symbols; the d_{sym} symbols after the dₛₗₒₜₛ slots are downlink symbols; the u_{sym} symbols before the last uₛₗₒₜₛ are uplink symbols; and the remaining (S-dₛₗₒₜ-uₛₗₒₜ)*N_{sym}-d_{sym}-u_{sym} are flexible symbols, where N_{sym} is the number of symbols in a slot.

For example, assuming that subcarrier spacing (SCS) of 30 KHz is employed, and dl-ul-TransmissionPeiodicity=5 ms, nrofDownlinkSlots=3, nrofUplinkSlots=3, nrofDownlinkSymbols=7, and nrofUplinkSymbols=3, a slot format for 10 slots within the slot configuration period is shown in FIG. 2A. That is, among the 10 slots, the first 3 slots are DL slots, the first 7 symbols of the fourth slot are DL symbols, the last 3 slots are UL slots, the last 3 symbols of the last but three slots are UL symbols, and the remaining slots or symbols are flexible (i.e., a total of 46 flexible symbols). In this example, the 46 flexible symbols may be served as the guard period for DL to UL switching.

In some embodiments of the present disclosure, a UE may be further provided with a UE specific UL/DL configuration via radio resource control (RRC) signaling (e.g., tdd-UL-DL-ConfigDedicated). In some embodiments, the UE specification configuration may override only flexible symbols per slot over the number of slots as provided by the cell common UL/DL configuration.

For example, a UE specific UL/DL configuration may indicate one or more of the following:
a set of slot configurations (e.g., by slotSpecificConfigurationsToAddModList)
for each slot configuration from the set of slot configurations
   a slot index for a slot (e.g., provided by slotIndex)
   a set of symbols for a slot (e.g., provided by symbols) where
      if symbols=allDownlink, all symbols in the slot are downlink
      if symbols=allUplink, all symbols in the slot are uplink
      if symbols=explicit, a number of downlink symbols (e.g., provided by nrofDownlinkSymbols) provides a number of downlink first symbols in the slot and a number of downlink symbols (e.g., provided by nrofUplinkSymbols) provides a number of uplink last symbols in the slot. If nrofDownlinkSymbols is not provided, there are no downlink first symbols in the slot and if nrofUplinkSymbols is not provided, there are no uplink last symbols in the slot. The remaining symbols in the slot are flexible.

For each slot having a corresponding index provided by the slot index (e.g., slotIndex) in the UE specific UL/DL configuration, the UE may apply a format according to the corresponding set of symbols (e.g., symbols) for the slot in the UE specific UL/DL configuration. The UE may not expect a UE specific UL/DL configuration to indicate a symbol that a cell common UL/DL configuration indicates downlink (or uplink) as uplink (or downlink).

FIG. 2B shows an example slot format based on FIG. 2A. In FIG. 2B, a UE specific UL/DL configuration indicates: slotindex=3, symbols=explicit, nrofDownlinkSymbols=8. That is, in FIG. 2B, the first 8 symbols of the 4th slot are DL symbols and the remaining 6 symbols of the 4th slot are flexible symbols.

In some embodiments of the present disclosure, the transmission directions of the flexible symbols can be indicated by dynamic signaling. Such signaling may carry a slot format indicator (SFI) and may be received by a configured group of one or more devices (e.g., UEs). For example, a DCI format (e.g., DCI format 2_0) may indicate an SFI, which may change a transmission direction of a flexible symbol(s) configured by a previous configuration (e.g., a UE specific UL/DL configuration) into UL or DL.

As mentioned above, a communication system may support CA technology. In a CA scenario, a TDD format for different cells may be different. For example, a specific symbol on one cell of a UE may be indicated or configured as DL while the specific symbol on another cell of the UE may be indicated or configured as flexible or UL. In some examples, a UE may not support transmission and reception at the same symbol; and therefore, the UE may need to determine how to communicate (e.g., whether to transmit or receive) on such symbol. In some embodiments of the present disclosure, solutions that can determine how to transmit or receive in a cell when CA is employed are provided.

For example, in some embodiments, a UE may be configured with multiple serving cells. The UE may determine a reference cell for a symbol among the multiple cells. For example, the reference cell may be determined from a set of cells (denoted as cell set #1 for clarity) of the multiple serving cells. Then, the UE may perform collision handling among the multiple serving cells. For example, the UE may perform collision handling within a set of cells (denoted as cell set #2 for clarity) of the multiple serving cells based on the determined reference cell. In some embodiments, cell set #1 may include the configured multiple cells or a subset of the configured multiple cells. In some embodiments, cell set #2 may include the configured multiple cells or a subset of the configured multiple cells. Cell set #1 and cell set #2 may be the same or different.

For example, in some embodiments, when a UE: (1) is configured with multiple serving cells, and directional collision handling is enabled (e.g., directionalCollisionHandling-r16=‘enabled’ as specified in 3GPP specifications) for a set of serving cells (e.g., cell set #2) among the configured serving cells; (2) indicates support of capability half-duplex (e.g., support of half-DuplexTDD-CA-SameSCS-r16 as specified in 3GPP specifications); and (3) is not configured to monitor a PDCCH for detection of DCI format 2_0 (which notifies the UE or a group of UEs of the slot format) on any of the configured serving cells, the UE determines a reference cell for a symbol (e.g., as an active cell) with (for example) the smallest cell index among a set of serving cells (e.g., cell set #1).

In some examples, cell set #1 may be
the configured multiple serving cells if the UE is not capable of simultaneous transmission and reception (e.g., as indicated by simultaneousRxTxInterBandCA as specified in 3GPP specifications) among the configured multiple serving cells; or
the cells of each band respectively if the UE is capable of simultaneous transmission and reception (e.g., as indicated by simultaneousRxTxInterBandCA) for the configured multiple serving cells,
   where the symbol is configured as
DL, or UL, as indicated by a higher layer configuration (e.g., a cell common UL/DL configuration such as tdd-UL-DL-ConfigCommon as specified in 3GPP specifications, or a UE specific UL/DL configuration such as tdd-UL-DL-ConfigDedicated as specified in 3GPP specifications);
UL, if the symbol is flexible (e.g., as indicated by the higher layer configuration) and the UE is configured to perform UL transmission (e.g., to transmit a sounding reference signal (SRS), a physical uplink control channel (PUCCH), a physical uplink shared channel (PUSCH), or a physical random access channel (PRACH)) on the symbol; or
DL, if the symbol is flexible (e.g., as indicated by the higher layer configuration) and the UE is configured to perform DL reception (e.g., to receive a PDCCH, a physical downlink shared channel (PDSCH) or a channel state information reference signal (CSI-RS)) on the symbol.

For example, the cell on which the symbol is indicated as flexible without any configured UL transmission or DL reception may be excluded from being selected as the reference cell for the symbol.

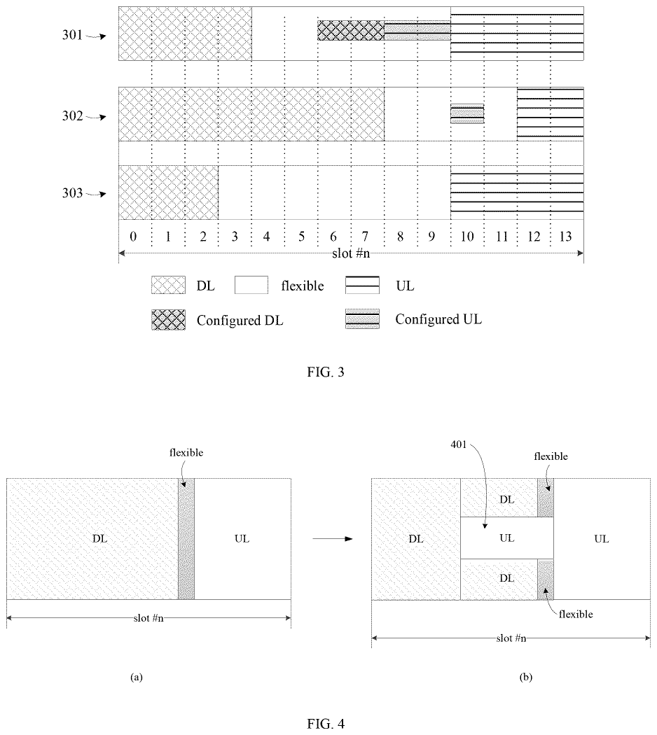

FIG. 3 illustrates an exemplary slot format in a CA scenario in accordance with some embodiments of the present disclosure. In the context of the present disclosure, it is assumed that a slot may include 14 symbols, indicated as symbols 0-13.

Referring to FIG. 3, multiple cells (e.g., cells 301-303) may be configured for a UE. The symbol formats (e.g., UL, DL or flexible) of the symbols in slot #n on each of cells 301-303 are configured or indicated (e.g., by a cell common UL/DL configuration or a UE specific UL/DL configuration) as shown in FIG. 3.

For example, symbols 0-2 on cell 303, symbols 0-7 on cell 302 and symbols 0-3 on cell 301 are DL, symbols 3-9 on cell 303, symbols 8-11 on cell 302 and symbols 4-9 on cell 301 are flexible, and symbols 10-13 on cell 303, symbols 12 and 13 on cell 302 and symbols 10-13 on cell 301 are UL. For example, the UE may be further configured to perform a DL reception in symbols 6 and 7 on cell 301, a UL transmission in symbols 8 and 9 on cell 301, and a UL transmission in symbol 10 on cell 302.

In some embodiments of the present disclosure, it is further assumed that the UE is provided with directionalCollisionHandling-r16=‘enabled’ for cells 301-303, indicates support of half-DuplexTDD-CA-SameSCS-r16 capability, and is not configured to monitor a PDCCH for detection of DCI format 2_0 on any of cells 301-303. According to the aforementioned method, the UE may determine a reference cell for each of symbols 0-13. It is assumed that the cell index of cell 301 is the smallest while the cell index of cell 303 is the largest.

For example, since symbols 0-2 on cells 301-303 are all downlink symbols, cell 301 (e.g., with the smallest cell index) is therefore the reference cell. Since symbols 3, 6, and 7 on cell 303 are flexible and not configured with any UL transmission or DL reception, the reference cell for these symbols should be selected from cell 301 and cell 302, and cell 301 (e.g., with the smallest cell index) is determined as the reference cell. Since symbols 4 and 5 on cell 303 and cell 301 are flexible and not configured with any UL transmission or DL reception, the reference cell for these symbols should be cell 302. Since symbols 8 and 9 on cell 302 and cell 303 are flexible and not configured with any UL transmission or DL reception, the reference cell for these symbols should be cell 301. Similarly, for the reference cell for symbols 10-13 should be cell 301.

In some embodiments of the present disclosure, after determining the reference cell for a symbol, the UE may determine how to transmit or receive in a cell on the symbol. For example, the UE may perform a procedure for directional collision handling among the configured cells (e.g., within a set of cells such as cell set #2). For example, cell set #2 may have been configured with directionalCollisionHandling-r16.

In some embodiments of the present disclosure, if a cell (e.g., a cell different from the reference cell which is referred to as “another cell” hereinafter) among cell set #2 operates in the same frequency band as the reference cell (e.g., intra-band), the UE does not expect at least one of the following:
a symbol to be indicated as downlink or uplink on the reference cell and as uplink or downlink on another cell, respectively, by a higher layer configuration (e.g., a cell common UL/DL configuration such as tdd-UL-DL-ConfigCommon or a UE specific UL/DL configuration such as tdd-UL-DL-ConfigDedicated) (hereinafter, scenario A1);
a higher layer configuration (e.g., a cell common UL/DL configuration such as tdd-UL-DL-ConfigCommon or a UE specific UL/DL configuration such as tdd-UL-DL-ConfigDedicated) to indicate a symbol as downlink on the reference cell and to detect a DCI format scheduling a transmission on the symbol on another cell (hereinafter, scenario B1); or
to be configured to perform a DL reception (e.g., configured by higher layers to receive a PDCCH, PDSCH, or CSI-RS) on a flexible symbol on the reference cell and to detect a DCI format scheduling a transmission on the symbol on another cell (hereinafter, scenario C1).

In some embodiments, when any of the above scenarios A1-C1 occurs, the UE may determine an error case.

In some embodiments of the present disclosure, if the reference cell and another cell (e.g., a cell among cell set #2) operate in different frequency bands (e.g., inter-band), the UE:
assumes the symbol as flexible, and/or is not required to receive configured data/signaling in the symbol (e.g., receive a higher layer configured PDCCH, PDSCH, or CSI-RS) and not expected to transmit configured data/signaling in the symbol (e.g., transmit a higher layer configured SRS, PUCCH, PUSCH, or PRACH), when the higher layer configuration (e.g., a cell common UL/DL configuration such as tdd-UL-DL-ConfigCommon or a UE specific UL/DL configuration such as tdd-UL-DL-ConfigDedicated) indicates the symbol as downlink or uplink on another cell and as uplink or downlink for the reference cell, respectively (hereinafter, scenario A2);
transmits a signal/channel scheduled by a DCI format on a symbol of another cell when the symbol is indicated as downlink by the higher layer configuration (e.g., a cell common UL/DL configuration such as tdd-UL-DL-ConfigCommon or a UE specific UL/DL configuration such as tdd-UL-DL-ConfigDedicated) for the reference cell (hereinafter, scenario B2); and/or
is not required to receive configured data/signaling (e.g., receive a higher layer configured PDCCH, PDSCH, or CSI-RS) on flexible symbols on the reference cell in a set of symbols, if the UE detects a DCI format scheduling a transmission on one or more symbols in the set of symbols on another cell (hereinafter, scenario C2).

In some embodiments of the present disclosure, in scenario A2, dynamically scheduled transmission or reception (e.g., by a DCI format) can be performed.

In some embodiments of the present disclosure, regardless of whether the reference cell and another cell (e.g., a cell among cell set #2) operate in the same or different frequency bands, the UE:
does not expect the higher layer configuration (e.g., a cell common UL/DL configuration such as tdd-UL-DL-ConfigCommon or a UE specific UL/DL configuration such as tdd-UL-DL-ConfigDedicated) for the reference cell to indicate a symbol as uplink and to detect a DCI format scheduling a reception downlink on the symbol on another cell (hereinafter, scenario A3);
does not expect to be configured to perform a UL transmission (e.g., by higher layers to transmit an SRS, PUCCH, PUSCH, or PRACH) on a flexible symbol on the reference cell and to detect a DCI format scheduling a reception on the symbol on another cell (hereinafter, scenario B3);
does not perform a UL transmission (e.g., transmit a PUCCH, PUSCH or PRACH) that is configured by higher layers on a set of symbols on another cell if at least one symbol from the set of symbols is indicated as downlink by the higher layer configuration (e.g., a cell common UL/DL configuration such as tdd-UL-DL-ConfigCommon or a UE specific UL/DL configuration such as tdd-UL-DL-ConfigDedicated) or is a symbol corresponding to a DL reception (e.g., a PDCCH, PDSCH, or CSI-RS reception) that is configured by higher layers on the reference cell (hereinafter, scenario C3);
does not perform a UL transmission (e.g., transmit an SRS) that is configured by higher layers on a set of symbols on another cell if the set of symbols is indicated as downlink by the higher layer configuration (e.g., a cell common UL/DL configuration such as tdd-UL-DL-ConfigCommon or a UE specific UL/DL configuration such as tdd-UL-DL-ConfigDedicated) or corresponds to a DL reception (e.g., a PDCCH, PDSCH or CSI-RS reception) that is configured by higher layers on the reference cell (hereinafter, scenario D3);
does not perform a DL reception (e.g., receive a PDCCH, PDSCH or CSI-RS) that is configured by higher layers on a set of symbols on another cell if at least one symbol from the set of symbols is indicated as uplink by the higher layer configuration (e.g., a cell common UL/DL configuration such as tdd-UL-DL-ConfigCommon or a UE specific UL/DL configuration such as tdd-UL-DL-ConfigDedicated) or is a symbol corresponding to a UL transmission (e.g., a SRS, PUCCH, PUSCH, or PRACH transmission) that is configured by higher layers on the reference cell (hereinafter, scenario E3);
assumes a symbol indicated as downlink or uplink by the higher layer configuration (e.g., a cell common UL/DL configuration such as tdd-UL-DL-ConfigCommon or a UE specific UL/DL configuration such as tdd-UL-DL-ConfigDedicated) on another cell to be flexible, if the UE is configured to perform a UL transmission (e.g., by higher layers to transmit an SRS, PUCCH, PUSCH, or PRACH) or to perform a DL reception (e.g., receive a PDCCH, PDSCH, or CSI-RS) on the reference cell (hereinafter, scenario F3); and/or
does not expect to detect a DCI format scheduling a transmission or reception on a symbol on a first cell (e.g., reference cell or another cell) and another DCI format scheduling a reception or transmission on the symbol on a second cell (e.g., another cell or reference cell), respectively (hereinafter, scenario G3).

In some embodiments, when any of the above scenarios A3, B3 and G3 occurs, the UE may determine an error case.

After the UE applies the procedures described above for directional collision handling within cell set #2, the UE does not expect any directional collision among the serving cells that the UE is not capable of simultaneous transmission and reception.

In some embodiments of the present disclosure, the above collision handling method can be implemented as in the following table.

TABLE 1
Directional Collision Handling

| | | Handling | |
|---|---|---|---|
| | | for | |
| Reference cell | Another cell | intra-band | Handling for inter-band |
| Semi-D | Semi-U | Error | Assumes symbol as flexible, |
| | | | is not required to receive or |
| | | | transmit configured data in |
| | | | the symbol |
| Semi-U | Semi-D | Error | Assumes symbol as flexible, |
| | | | is not required to receive or |
| | | | transmit configured data in |
| | | | the symbol |
| Semi-D | Dynamic U | Error | Transmits a signal/channel |
| | | | scheduled by a DCI format |
| | | | on a symbol of another cell |
| Configured D on | Dynamic U | Error | Cancels configured D |
| flexible | | | |

| Semi-U | Dynamic D | Error |
|---|---|---|
| Configured U on | Dynamic D | error |
| flexible | | |
| Semi-D/Configured | Configured U | Cancels the transmission in another cell |
| D | | |
| Semi-U/Configured | Configured D | Cancels the reception in another cell |
| U | | |
| Configured D/U | Semi-U/D | Assumes symbol as flexible |
| Dynamic D/U | Dynamic U/D | Error |

In Table 1, “Semi-D,” “Semi-U,” “Flexible,” “Dynamic U,” “Dynamic D,” “Configured U,” and “Configured D” are transmission or reception types of a cell (e.g., the reference cell or the another cell). In particular, “Semi-D” may represent “DL symbol format configured by a higher layer configuration (e.g., tdd-UL-DL-ConfigCommon or tdd-UL-DL-ConfigDedicated)”; “Semi-U” may represent “UL symbol format configured by a higher layer configuration (e.g., tdd-UL-DL-ConfigCommon or tdd-UL-DL-ConfigDedicated)”; “Flexible” may represent “flexible symbol format configured by a higher layer configuration (e.g., tdd-UL-DL-ConfigCommon or tdd-UL-DL-ConfigDedicated)”; “Dynamic U” may represent “DCI format scheduling a transmission or reception”; “Dynamic D” may represent “DCI format scheduling a reception”; “Configured U” may represent “a PUCCH, PUSCH or PRACH that is configured by higher layers”; “Configured D” may represent “higher layer configured PDCCH, PDSCH, or CSI-RS”; “Configured U on flexible” may represent a combination of “Flexible” and “Configured U”; and “Configured D on flexible” may represent a combination of “Flexible” and “Configured D.”

In order to realize a superior data rate and reduce latency in a wireless system (e.g., 5G system), a spectrum on higher frequency band is inevitable. However, a big question is how to overcome coverage reduction on such carriers. To solve the problem, a duplexing scheme that enables simultaneous use of downlink and uplink within a TDD carrier using a non-overlapping frequency resource (which may be referred to as “subband non-overlapping full duplex (SBFD)”) may be employed. The subband (also referred to as UL subband) may refer to a bandwidth part (BWP) of a serving cell of a UE or a part of a BWP of a serving cell of a UE. One intention of this scheme is to extend the duration over which uplink transmission can occur for improving uplink coverage and capacity. For example, a BS may simultaneously perform a downlink transmission and an uplink transmission (for example, on different UEs) in the SBFD symbol or slot.

FIG. 4 illustrates an exemplary subband full duplex scheme in accordance with some embodiments of the present disclosure.

Referring to FIG. 4, a UE may determine a slot format (a) for slot #n according to, for example, a higher layer configuration (e.g., a cell common UL/DL configuration or a UE specific UL/DL configuration) or an SFI. The UE may further receive signaling (e.g., a higher layer configuration or an SFI), which may indicate at least one DL symbol, at least one flexible symbol, at least one DL slot, at least one flexible slot, or any combination thereof to be subband full duplex or subband non-overlapping full duplex. For example, the UE may receive signaling indicating a frequency domain resource and time domain resource of a UL subband or a UL frequency region for SBFD, which can override a DL symbol(s), a flexible symbol(s), or both. For example, the UE may be configured with a UL subband 401 and determine a slot format (b) for slot #n as shown in FIG. 4.

There may be four symbol formats in a system adopting the subband full duplex scheme. The four symbol formats include DL, flexible, SBFD, and UL. For example, a DL or UL symbol may mean that the transmission direction on this symbol is DL or UL. For example, a flexible symbol may mean that a UE cannot make any assumptions on the transmission direction of this symbol. For example, an SBFD symbol may mean that this symbol can support simultaneous DL and UL transmissions in the BS side. For example, a symbol being SBFD may mean the symbol being indicated as DL with a UL frequency region or a UL subband; the symbol being indicated as flexible with a UL frequency region or a UL subband; or the symbol being indicated as flexible and a DL reception and a UL reception being configured to be performed in the symbol simultaneously (e.g., configured by a BS for a UE). For example, an SBFD symbol may include a UL frequency domain resource or UL subband and be initially indicated or configured by a high layer configuration or an SFI from a BS as downlink or flexible (for example, there could be at least two subbands or frequency domain regions with different transmission directions in this symbol). For example, a BS may simultaneously perform a DL transmission and a UL reception in an SBFD symbol while a UE can only perform a DL reception or a UL transmission. For example, an SBFD symbol may be configured with a UL subband, a DL subband, a flexible subband or any combination thereof. For example, an SBFD symbol may include a UL subband configuration (e.g., UL subband 401 in FIG. 4).

It should be noted that another name may be used to denote the SBFD symbol as described above, for example, a symbol with a UL frequency domain resource/region or a symbol with a UL subband. In the context of the present disclosure, a non-SBFD symbol may refer to a DL, flexible, or UL symbol. In some examples, a DL, flexible, or UL symbol may mean that a DL, flexible, or UL symbol without SBFD.

Embodiments of the present disclosure further provide solutions for determining whether to transmit or receive on a symbol when CA and SBFD are supported. For example, solutions for determining the reference cell are provided. For example, solutions for determining the transmission or reception type of a cell (e.g., the reference cell or the another cell) are provided. For example, solutions for performing collision handling between cells (e.g., between the reference cell and the another cell) are provided. More details on the embodiments of the present disclosure will be illustrated in the following text in combination with the appended drawings.

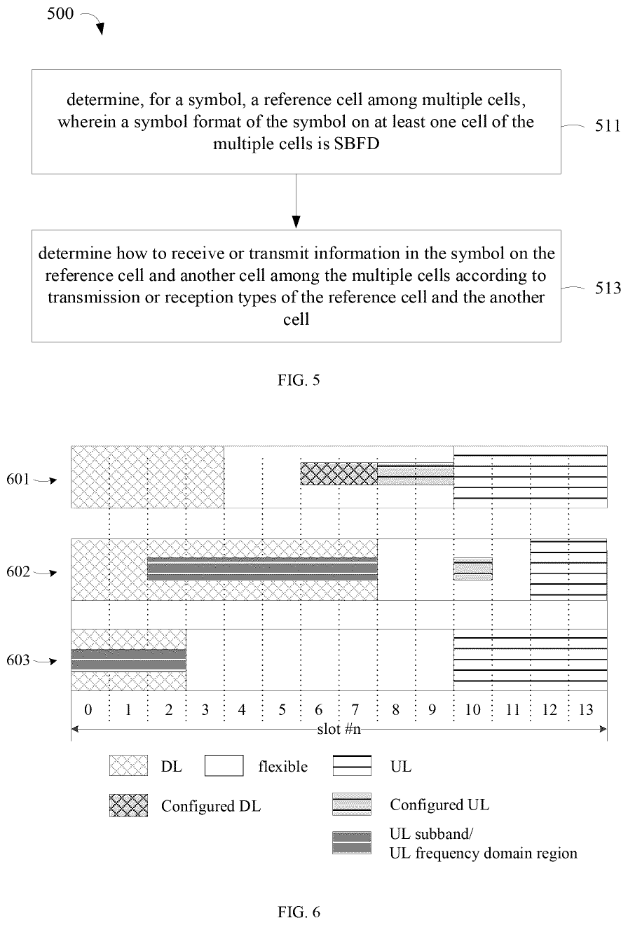

FIG. 5 illustrates a flow chart of exemplary procedure 500 for determining how to transmit or receive on a symbol in accordance with some embodiments of the present disclosure. Procedure 500 may be implemented by a UE (e.g., UE 101 as shown in FIG. 1). Details described in all of the foregoing embodiments of the present disclosure are applicable for the embodiments shown in FIG. 5.

In some embodiments of the present disclosure, the UE may be configured with multiple serving cells by a BS. In some embodiments of the present disclosure, directional collision handling may be enabled (e.g., directionalCollisionHandling-r16=‘enabled’ as specified in 3GPP specifications) for a set of serving cells (e.g., cell set #2) among the multiple serving cells. In some embodiments of the present disclosure, the UE may indicate support of half-duplex capability (e.g., support of half-DuplexTDD-CA-SameSCS-r16 as specified in 3GPP specifications). In some embodiments of the present disclosure, the UE may not be configured to monitor a PDCCH for detection of DCI format 2_0 on any of the multiple serving cells.

In some embodiments of the present disclosure, the UE may support SBFD. In some embodiments of the present disclosure, when a UE supports SBFD, it may also support half-DuplexTDD-CA-SameSCS-r16.

Referring to FIG. 5, in operation 511, the UE may determine, for a symbol (denoted as symbol #A), a reference cell among the multiple cells, wherein a symbol format of symbol #A on at least one cell of the multiple cells is SBFD. The UE may a respective cell for each symbol in one or more slots.

The aforementioned descriptions with respect to symbol format may apply here. For example, in some embodiments of the present disclosure, the symbol format of a symbol may include DL, UL, flexible, or SBFD. In some embodiments, as also mentioned above, the symbol format being DL, UL, or flexible may mean that the symbol format is DL but not SBFD, UL but not SBFD, or flexible but not SBFD.

For example, a symbol format of a symbol may be indicated by higher layer signaling from the BS. For example, the higher layer signaling may include a higher layer configuration (e.g., tdd-UL-DL-ConfigCommon or tdd-UL-DL-ConfigDedicated) or DCI format 2_0. The UE may receive such signaling from the BS and then would know the symbol format of each symbol.

For example, in some embodiments of the present disclosure, the symbol format of a symbol (e.g., symbol #A) being SBFD may include at least one of the following: the symbol being indicated as DL with a UL frequency region or a UL subband (case #1); the symbol being indicated as flexible with a UL frequency region or a UL subband (case #2); or the symbol being indicated as flexible and a DL reception and a UL transmission being configured to be performed in the symbol simultaneously (case #3). For example, when symbol #A is indicated as DL with a UL frequency region on a cell (denoted as cell #A) of the multiple cells, the symbol format of symbol #A on cell #A is SBFD. In some embodiments, case #1 may also be referred to as “DL and SBFD,” and case #2 and case #3 may also be referred to as “flexible and SBFD.”

Various methods may be employed by the UE for determining the reference cell in operation 511.

For example, in some embodiments of the present disclosure, when the symbol format of a symbol on a certain cell of the multiple cells is SBFD, this cell cannot be selected as the reference cell for the symbol. In some embodiments, to avoid the case where no suitable cell can be determined as a reference cell, the symbol format of a symbol on at least one cell of the multiple cells is not SBFD.

For example, in some embodiments, the symbol format of symbol #A on the reference cell is not SBFD. In some embodiments, the symbol format of symbol #A on the reference cell can be: DL but not SBFD or UL as indicated by a higher layer configuration; UL, if symbol #A is indicated as flexible but not SBFD, and a UL transmission is configured to be performed in symbol #A; UL, if symbol #A is indicated as flexible, a UL transmission is configured to be performed in symbol #A and a DL reception is not configured to be performed in symbol #A; UL, if symbol #A is indicated as flexible and SBFD, a UL transmission is configured to be performed in symbol #A and a DL reception is not configured to be performed in symbol #A; DL, if symbol #A is indicated as flexible but not SBFD, and a DL reception is configured to be performed in symbol #A; DL, if symbol #A is indicated as flexible, a DL reception is configured to be performed in symbol #A, and a UL transmission is not configured to be performed in symbol #A; or DL, if symbol #A is indicated as flexible and SBFD, a DL reception is configured to be performed in symbol #A, and a UL transmission is not configured to be performed in symbol #A.

For example, in some embodiments, the reference cell for symbol #A is from a set of cells of the multiple cells, wherein the symbol format of symbol #A on each cell of the set of cells is not SBFD. In some embodiments, a symbol format of symbol #A on a cell of the set of cells is: DL but not SBFD or UL as indicated by a higher layer configuration; UL, if symbol #A is indicated as flexible but not SBFD, and a UL transmission is configured to be performed in symbol #A; UL, if symbol #A is indicated as flexible, a UL transmission is configured to be performed in symbol #A and a DL reception is not configured to be performed in symbol #A; UL, if symbol #A is indicated as flexible and SBFD, a UL transmission is configured to be performed in symbol #A and a DL reception is not configured to be performed in symbol #A; DL, if symbol #A is indicated as flexible but not SBFD, and a DL reception is configured to be performed in symbol #A; DL, if symbol #A is indicated as flexible, a DL reception is configured to be performed in symbol #A, and a UL transmission is not configured to be performed in symbol #A; or DL, if symbol #A is indicated as flexible and SBFD, a DL reception is configured to be performed in symbol #A, and a UL transmission is not configured to be performed in symbol #A.

In some embodiments, the UE may determine the reference cell for symbol #A as an active cell with the smallest cell index among the set of cells.

In the context of the present disclosure, generally speaking, when a symbol is indicated as flexible and SBFD on a cell, the symbol format of the symbol on the cell should be SBFD. However, as described above, under certain scenarios, the symbol format of the symbol on the cell may be deemed as UL or DL, and thus the cell can be selected as the reference cell for the symbol. For example, as described above, such scenarios may include: if a symbol is indicated as flexible and SBFD, a UL transmission is configured to be performed in the symbol and a DL reception is not configured to be performed in the symbol, the symbol format of the symbol may be deemed as UL during reference cell selection; and if a symbol is indicated as flexible and SBFD, a DL reception is configured to be performed in the symbol, and a UL transmission is not configured to be performed in the symbol, the symbol format of the symbol may be deemed as DL during reference cell selection.

In the context of the present disclosure, the feature “a UL transmission or DL reception being configured to be performed in a symbol” is defined with respect to a UE, and means that the UE may be configured by a BS to perform a UL transmission or DL reception in a symbol. In the context of the present disclosure, the feature “a DL transmission or UL reception being configured to be performed in a symbol” is defined with respect to a BS, and means that the BS may configure a UE to perform a UL transmission or DL reception in a symbol and may correspondingly perform a DL transmission or UL reception in the symbol.

In the context of the present disclosure, from the perspective of a UE, performing a UL transmission may include transmitting an SRS, a PUCCH, a PUSCH, or a PRACH, and performing a DL reception may include receiving a PDCCH, a PDSCH or a CSI-RS. From the perspective of a BS, performing a UL reception may include receiving an SRS, a PUCCH, a PUSCH, or a PRACH, and performing a DL transmission may include transmitting a PDCCH, a PDSCH or a CSI-RS.

In some examples, the above method for determining the reference cell may be standardized as follows:

the UE determines a reference cell for a symbol as an active cell with the smallest cell index among
the configured multiple serving cells if the UE is not capable of simultaneous transmission and reception as indicated by simultaneousRxTxInterBandCA among the multiple serving cells, and
the cells of each band respectively if the UE is capable of simultaneous transmission and reception by simultaneousRxTxInterBandCA for the configured multiple serving cells,
   where the symbol is:
downlink but not SBFD (or downlink, or downlink without UL subband, or downlink without UL frequency domain region), or uplink, as indicated by tdd-UL-DL-ConfigurationCommon or tdd-UL-DL-ConfigDedicated;
uplink, if the symbol is indicated as flexible but not SBFD (or flexible, or flexible without UL subband, or flexible without UL frequency domain region), and the UE is configured to transmit an SRS, PUCCH, PUSCH, or PRACH on the symbol;
uplink, if the symbol is indicated as flexible and the UE is configured to transmit an SRS, PUCCH, PUSCH, or PRACH on the symbol, but is not configured to receive a PDCCH, PDSCH or CSI-RS on the symbol;
uplink, if the symbol is indicated as flexible and SBFD and the UE is configured to transmit an SRS, PUCCH, PUSCH, or PRACH on the symbol, but is not configured to receive a PDCCH, PDSCH or CSI-RS on the symbol;
downlink, if the symbol is indicated as flexible not SBFD (or flexible, or flexible without UL subband, or flexible without UL frequency domain region) and the UE is configured to receive a PDCCH, PDSCH or CSI-RS on the symbol;
downlink, if the symbol is indicated as flexible and SBFD and the UE is configured to receive a PDCCH, PDSCH or CSI-RS on the symbol, but is not configured to transmit an SRS, PUCCH, PUSCH, or PRACH on the symbol; or
downlink, if the symbol is indicated as flexible and the UE is configured to receive a PDCCH, PDSCH or CSI-RS on the symbol, but is not configured to transmit an SRS, PUCCH, PUSCH, or PRACH on the symbol.

FIG. 6 illustrates an exemplary schematic diagram for determining a reference cell in accordance with some embodiments of the present disclosure.

Referring to FIG. 6, multiple cells (e.g., cells 601-303) may be configured for a UE. The symbol formats (e.g., UL, DL, flexible, or SBFD) of the symbols in slot #n on each of cells 601-303 are configured or indicated (e.g., by a cell common UL/DL configuration or a UE specific UL/DL configuration) as shown in FIG. 6.

For example, symbols 0-3 on cell 601 are indicated as DL (or DL but not SBFD), symbols 4-9 on cell 601 are indicated as flexible (or flexible but not SBFD), and symbols 10-13 on cell 601 are indicated as UL. Symbols 0-1 on cell 602 are indicated as DL (or DL but not SBFD), symbols 2-7 on cell 602 are indicated as SBFD (or DL and SBFD, or DL with UL subband, or DL with UL frequency domain region), symbols 8-11 on cell 602 are indicated as flexible (or flexible but not SBFD), and symbols 12-13 on cell 602 are indicated as UL. Symbols 0-2 on cell 603 are indicated as SBFD (or DL and SBFD, or DL with UL subband, or DL with UL frequency domain region), symbols 3-9 on cell 603 are indicated as flexible (or flexible but not SBFD), and symbols 10-13 on cell 603 are indicated as UL.

In some embodiments of the present disclosure, it is further assumed that in the example of FIG. 6, the UE is provided with directionalCollisionHandling-r16=‘enabled’ for cells 601-603, indicates support of half-DuplexTDD-CA-SameSCS-r16 capability, and is not configured to monitor a PDCCH for detection of DCI format 2_0 on any of cells 601-603. It is assumed that the cell index of cell 601 is the smallest while the cell index of cell 603 is the largest.

In some embodiments of the present disclosure, the UE may determine a reference cell for each of symbols 0-13 according to the aforementioned method.

For example, since symbols 0-1 on cell 603 are SBFD symbols, the corresponding reference cells are therefore selected from cells 601 and 602, and cell 601 (e.g., with the smallest cell index) is the reference cell for symbols 0-1. Since symbol 2 is an SBFD symbol on cells 602 and 603, the reference cell for symbol 2 is therefore cell 601. Since symbol 3 is a flexible symbol without any UL transmission or DL reception on cell 603 and is an SBFD symbol on cell 602, the corresponding reference cell is therefore selected from cell 601. Since symbols 6 and 7 are SBFD symbols on cell 602 and are flexible symbols without any UL transmission or DL reception on cell 603, the corresponding reference cells are therefore selected from cell 601. Since symbols 8 and 9 are flexible symbols without any UL transmission or DL reception on cells 602 and 603, the corresponding reference cells are therefore selected from cell 601. Similarly, the reference cell for symbols 10, 12, and 13 should be selected from cells 601-603, and cell 601 (e.g., with the smallest cell index) should be selected. The reference cell for symbol 11 should be selected from cells 601 and 603, and cell 601 (e.g., with the smallest cell index) should be selected.

Referring back to FIG. 5, the following alternative method may be employed by the UE for determining the reference cell. For example, in some embodiments of the present disclosure, when the symbol format of a symbol on a certain cell of the multiple cells is SBFD, this cell can be selected as the reference cell for the symbol.

For example, in some embodiments, the symbol format of symbol #A on the reference cell can be: SBFD, if symbol #A is indicated as SBFD by a higher layer configuration (e.g., symbol #A is indicated as DL with UL subband, DL with UL frequency domain region, flexible with UL subband, flexible with UL frequency domain region, or flexible with a downlink DL reception and a UL transmission being configured to be performed in symbol #A simultaneously); UL, if symbol #A is indicated as SBFD by a higher layer configuration; UL, if symbol #A is indicated as flexible, a UL transmission is configured to be performed in symbol #A and a DL reception is not configured to be performed in symbol #A; DL, if symbol #A is indicated as flexible, a DL reception is configured to be performed in symbol #A, and a UL transmission is not configured to be performed in symbol #A; UL, if symbol #A is indicated as flexible and SBFD, a UL transmission is configured to be performed in symbol #A and a DL reception is not configured to be performed in symbol #A; or DL, if symbol #A is indicated as flexible and SBFD, and a DL reception is configured to be performed in symbol #A, and a UL transmission is not configured to be performed in symbol #A.

For example, in some embodiments, the symbol format of symbol #A on the reference cell can be: UL, or DL, as indicated by a higher layer configuration; UL, if symbol #A is indicated as flexible and a UL transmission is configured to be performed in symbol #A; or DL, if symbol #A is flexible and a DL reception is configured to be performed in symbol #A.

In some examples, the above method for determining the reference cell may be standardized as follows:
the UE determines a reference cell for a symbol as an active cell with the smallest cell index among
   the configured multiple serving cells if the UE is not capable of simultaneous transmission and reception as indicated by simultaneousRxTxInterBandCA among the multiple serving cells, and
   the cells of each band respectively if the UE is capable of simultaneous transmission and reception by simultaneousRxTxInterBandCA for the configured multiple serving cells,
where the symbol is:
   downlink, uplink, or SBFD, as indicated by tdd-UL-DL-ConfigurationCommon or tdd-UL-DL-ConfigurationDedicated;
   uplink, if the symbol is indicated as flexible and the UE is configured to transmit an SRS, PUCCH, PUSCH, or PRACH on the symbol;
   downlink, if the symbol is indicated as flexible and the UE is configured to receive a PDCCH, PDSCH or CSI-RS on the symbol;
   SBFD, if the symbol is indicated as downlink with UL subband, or is downlink with UL frequency domain region;
   SBFD, if the symbol is indicated as flexible with UL subband, or is downlink with UL frequency domain region;
   SBFD, if the symbol is indicated as flexible and the UE is configured to receive a PDCCH, PDSCH or CSI-RS on the symbol, and is configured to transmit an SRS, PUCCH, PUSCH, or PRACH on the symbol;
   uplink, if the symbol is indicated as SBFD by tdd-UL-DL-ConfigurationCommon or tdd-UL-DL-ConfigurationDedicated or if the symbol is indicated as downlink with UL subband, or downlink with UL frequency domain region or if the symbol is indicated as flexible with UL subband, or with UL frequency domain region;
   uplink, if the symbol is indicated as flexible and the UE is configured to transmit an SRS, PUCCH, PUSCH, or PRACH on the symbol, but is not configured to receive a PDCCH, PDSCH or CSI-RS on the symbol;
   downlink, if the symbol is indicated as flexible and the UE is configured to receive a PDCCH, PDSCH or CSI-RS on the symbol, but is not configured to transmit an SRS, PUCCH, PUSCH, or PRACH on the symbol;
   uplink, if the symbol is indicated as flexible and SBFD, and the UE is configured to transmit an SRS, PUCCH, PUSCH, or PRACH on the symbol, but is not configured to receive a PDCCH, PDSCH or CSI-RS on the symbol; or
   downlink, if the symbol is indicated as flexible and SBFD, and the UE is configured to receive a PDCCH, PDSCH or CSI-RS on the symbol, but is not configured to transmit an SRS, PUCCH, PUSCH, or PRACH on the symbol.

For example, referring to FIG. 6, the UE may determine a reference cell for each of symbols 0-13 according to the aforementioned method.

For example, although symbols 0-1 on cell 603 are SBFD symbols, cell 603 can be a candidate for reference cell selection. That is, the reference cells for symbols 0-1 are selected from cells 601-603, and cell 601 (e.g., with the smallest cell index) is selected as the reference cell for symbols 0-1. Similarly, cells 602 and 603 can be candidates for reference cell selection for symbol 2. That is, the reference cell for symbol 2 is selected from cells 601-603, and cell 601 (e.g., with the smallest cell index) is selected as the reference cell for symbol 2. Since symbol 3 is a flexible symbol without any UL transmission or DL reception on cell 603, the corresponding reference cell is therefore selected from cells 601 and 602, and cell 601 (e.g., with the smallest cell index) is selected as the reference cell for symbol 3. Since symbols 4-5 are flexible symbols without any UL transmission or DL reception on cells 601 and 603, the corresponding reference cell is therefore selected from cell 602. Since symbols 6 and 7 are flexible symbols without any UL transmission or DL reception on cell 603, the corresponding reference cells are therefore selected from cells 601 and 602, and cell 601 (e.g., with the smallest cell index) should be selected. Since symbols 8 and 9 are flexible symbols without any UL transmission or DL reception on cells 602 and 603, the corresponding reference cells are therefore selected from cell 601. Similarly, the reference cell for symbols 10, 12, and 13 should be selected from cells 601-603, and cell 601 (e.g., with the smallest cell index) should be selected. The reference cell for symbol 11 should be selected from cells 601 and 603, and cell 601 (e.g., with the smallest cell index) should be selected.

Referring back to FIG. 5, in operation 513, the UE may determine how to receive or transmit information in a symbol (e.g., symbol #A) on the reference cell and another cell among the multiple cells according to the transmission or reception types of the reference cell and the another cell. The another cell may be a serving cell of the UE different from the reference cell. In some embodiments, the another cell may from a set of serving cells (e.g., cell set #2) with enabled directional collision handling (e.g., directionalCollisionHandling-r16=‘enabled’ as specified in 3GPP specifications) among the multiple serving cells.

The transmission or reception types of a cell may include at least one of Semi-D, Semi-U, Flexible, Dynamic U, Dynamic D, Configured U, Configured D, or SBFD. The definitions of Semi-D,” “Semi-U,” “Flexible,” “Dynamic U,” “Dynamic D,” “Configured U,” and “Configured D” as described above may apply here. The transmission or reception type “SBFD” may represent “SBFD configured by a higher layer configuration.”

In some examples, the transmission or reception type “SBFD” may refer to a transmission or reception type “Semi-D with SBFD,” which may represent “DL with UL subband configured by a higher layer configuration” or “DL with UL frequency domain region configured by a higher layer configuration.” In some examples, the transmission or reception type “SBFD” may refer to a transmission or reception type “Flexible with SBFD,” which may represent “flexible with both DL and UL subbands configured by a higher layer configuration” or “flexible with both DL and UL frequency domain region configured by a higher layer configuration.”

In the context of the present disclosure, a symbol being indicated or configured as a certain symbol format (e.g., SBFD, DL, UL, or flexible) may refer to a symbol being indicated or configured as such symbol format by a higher layer configuration (e.g., tdd-UL-DL-ConfigCommon or tdd-UL-DL-ConfigDedicated).

In some embodiments of the present disclosure, in the case that the another cell operates in the same frequency band as the reference cell, the UE does not expect at least one of the following: the symbol format of the symbol (e.g., symbol #A) to be indicated as DL on the reference cell and as SBFD on the another cell; or the symbol format of the symbol (e.g., symbol #A) to be indicated as UL on the reference cell and as SBFD on the another cell. In some embodiments, when any of the above scenarios occurs, the UE may determine an error case.

In some examples, the above error cases may be standardized as follows:
If another cell among the cells configured with directionalCollisionHandling-r16 operates in the same frequency band as the reference cell, the UE does not expect
   a symbol to be indicated as downlink on the reference cell and as downlink with UL subband on another cell, respectively, by tdd-UL-DL-ConfigurationCommon or by tdd-UL-DL-ConfigurationDedicated; and/or
   a symbol to be indicated as uplink on the reference cell and as downlink with UL subband on another cell, respectively, by tdd-UL-DL-ConfigurationCommon or by tdd-UL-DL-ConfigurationDedicated.

In some embodiments of the present disclosure, determining how to receive or transmit information in a symbol (e.g., symbol #A) on the reference cell and another cell among the multiple cells according to the transmission or reception types of the reference cell and another cell may include: (a) assuming the symbol as flexible, when the symbol is indicated as SBFD on the another cell and as UL or DL on the reference cell, or when the symbol is indicated as SBFD on the another cell and one of: a UL transmission is configured to be performed in the symbol on the reference cell and a DL reception is configured to be performed in the symbol on the reference cell; (b) assuming the symbol as DL, when the symbol is indicated as SBFD on the another cell and as DL on the reference cell, or when the symbol is indicated as SBFD on the another cell and a DL reception is configured to be performed in the symbol on the reference cell; (c) assuming a DL or UL frequency domain region in the symbol on the another cell as a flexible frequency domain region, when the symbol is indicated as SBFD on the another cell and as UL or DL on the reference cell, or when the symbol is indicated as SBFD on the another cell and one of: a UL transmission is configured to be performed in the symbol on the reference cell and a DL reception is configured to be performed in the symbol on the reference cell; or (d) determining not being required to receive configured data in the symbol or in a DL frequency domain region in the symbol on the another cell, or not being expected to transmit configured data in the symbol or in a UL frequency domain region in the symbol on the another cell, when the symbol is indicated as SBFD on the another cell and as UL or DL on the reference cell, or when the symbol is indicated as SBFD on the another cell and one of: a UL transmission is configured to be performed in the symbol on the reference cell and a DL reception is configured to be performed in the symbol on the reference cell.

The above scenarios (a)-(c) can be applied to the cases when the reference cell and the another cell operate in different frequency bands or the same frequency band.

In some examples, the above scenarios (a)-(c) may be standardized as follows. In the following examples and aforementioned examples, indicating a symbol as SBFD can be replaced by indicating a symbol as downlink with uplink subband, or indicating a symbol as downlink with uplink frequency domain region, or indicating a symbol as flexible with both uplink and downlink subbands, or indicating a symbol as flexible with both uplink and downlink frequency domain regions, and UL, DL, or flexible subband may be replaced by UL, DL, or flexible frequency domain region.
If the reference cell and another cell among the cells configured with directionalCollisionHandling-r16 operate in different frequency bands, or the same frequency band, the UE
   assumes symbol as flexible, is not required to receive a higher layer configured PDCCH, PDSCH, or CSI-RS and not expected to transmit a higher layer configured SRS, PUCCH, PUSCH, or PRACH, when tdd-UL-DL-ConfigurationCommon or tdd-UL-DL-ConfigurationDedicated indicates symbol as SBFD on another cell and as uplink or downlink on the reference cell, respectively;
   assumes symbol as downlink, when tdd-UL-DL-ConfigurationCommon or tdd-UL-DL-ConfigurationDedicated indicates symbol as SBFD on another cell and as downlink on the reference cell, respectively;
   assumes symbol as downlink, when tdd-UL-DL-ConfigurationCommon or tdd-UL-DL-ConfigurationDedicated indicates symbol as SBFD on another cell and if the UE is configured by higher layers to receive a PDCCH, PDSCH, or CSI-RS on the reference cell;
   assumes the UL subband or DL subband in the symbol of another cell as a flexible subband, is not required to receive a higher layer configured PDCCH, PDSCH, or CSI-RS in the DL subband, or not expected to transmit a higher layer configured SRS, PUCCH, PUSCH, or PRACH in the UL subband, when tdd-UL-DL-ConfigurationCommon or tdd-UL-DL-ConfigurationDedicated indicates symbol as SBFD on another cell and as uplink or downlink for the reference cell, respectively;
   is not required to receive a higher layer configured PDCCH, PDSCH, or CSI-RS in the downlink subband of another cell, or is not expected to transmit a higher layer configured SRS, PUCCH, PUSCH, or PRACH in the UL subband of another cell, when tdd-UL-DL-ConfigurationCommon or tdd-UL-DL-ConfigurationDedicated indicates symbol as SBFD on another cell and as uplink or downlink for the reference cell, respectively;
   assumes the DL subband or UL subband in a symbol indicated as SBFD by tdd-UL-DL-ConfigurationCommon or tdd-UL-DL-ConfigurationDedicated on another cell to be a flexible subband, if the UE is configured by higher layers to transmit an SRS, PUCCH, PUSCH, or PRACH or to receive a PDCCH, PDSCH, or CSI-RS on the reference cell;
   assumes the symbol indicated as SBFD by tdd-UL-DL-ConfigurationCommon or tdd-UL-DL-ConfigurationDedicated on another cell to be flexible, if the UE is configured by higher layers to transmit an SRS, PUCCH, PUSCH, or PRACH or to receive a PDCCH, PDSCH, or CSI-RS on the reference cell; and/or
   is not required to receive a higher layer configured PDCCH, PDSCH, or CSI-RS in the downlink subband of another cell, or is not expected to transmit a higher layer configured SRS, PUCCH, PUSCH, or PRACH in the UL subband of another cell, if a symbol indicated as by SBFD tdd-UL-DL-ConfigurationCommon or tdd-UL-DL-ConfigurationDedicated on another cell, and if the UE is configured by higher layers to transmit an SRS, PUCCH, PUSCH, or PRACH or to receive a PDCCH, PDSCH, or CSI-RS on the reference cell.

In some embodiments of the present disclosure, the above collision handling method can be implemented as in the following table.

TABLE 2
Directional Collision Handling

| Reference | Another | | Handling for |
|---|---|---|---|
| cell | cell | Handling for intra-band | inter-band |
| Semi-D | Semi-D | One of the following: | One of the following: |
| | with SBFD | 1. error; | 1. assumes UL subband |
| | or | 2. assumes UL subband as | as flexible subband (In |
| | SBFD | flexible subband (In such | such case, the UE could |
| | | case, the UE could receive | receive in the DL |
| | | in the DL subband); | subband); |
| | | 3. not expected to transmit | 2. not expected to |
| | | configured UL in the UL | transmit configured UL |
| | | subband; | in the UL subband; |
| | | 4. a combination of 2 and 3; | 3. a combination of 1 and 2; |
| | | 5. assuming the symbol as | 4. assuming the symbol |
| | | downlink symbol; or | as downlink symbol; or |
| | | 6. assuming the symbol as | 5. assuming the symbol |
| | | flexible symbol. | as flexible symbol. |
| Semi-U | Semi-D | One of the following: | One of the following: |
| | with SBFD | 1. error; | 1. assumes DL subband |
| | or | 2. assumes DL subband as | as flexible subband (In |
| | SBFD | flexible subband (In such | such case, the UE could |
| | | case, the UE could | transmit in the UL |
| | | transmit in the UL | subband); |
| | | subband); | 2. not required to receive |
| | | 3. not required to receive | configured DL in the DL |
| | | configured DL in the DL | subband; |
| | | subband; | 3. a combination of 1 and |
| | | 4. a combination of 2 and | 2; or |
| | | 3; or | 4. assume the symbols as |
| | | 3. assume the symbols as flexible. | flexible. |

| | | |
|---|---|---|
| Configured | Semi-D | One of the following: |
| D | with SBFD | 1. assumes the UL sub-band as flexible subband (In |
| | or | such case, the UE could receive in the DL subband); |
| | SBFD | 2. not expected to transmit configured UL in the UL |
| | | subband; |
| | | 3. a combination of 1 and 2; |
| | | 4. assumes the symbol as flexible; or |
| | | 5. assumes the symbol as downlink. |
| Configured | Semi-D | One of the following: |
| U | with SBFD | 1. assumes the DL subband as flexible subband |
| | or | (In such case, the UE could transmit in the UL subband); |
| | SBFD | 2. not required to receive configured DL in the DL sub-band; |
| | | 3. a combination of 1 and 2; or |
| | | 4. assumes the symbol as flexible. |

In some embodiments of the present disclosure, in the case that none of the transmission or reception types of the reference cell and the another cell are SBFD (e.g., the above Table 2 is not applicable), embodiments described above related with Table 1 may apply. In some embodiments of the present disclosure, after the UE applies the procedures described above for directional collision handling related with Tables 1 and 2, the UE does not expect any directional collision among the serving cells that the UE is not capable of simultaneous transmission and reception.

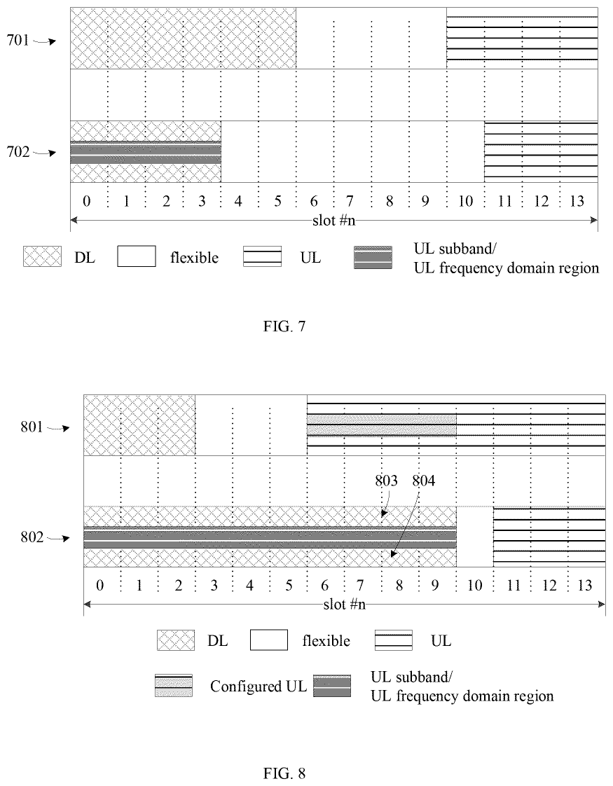

FIGS. 7 and 8 illustrate exemplary schematic diagrams for determining whether to receive or transmit information on a symbol in accordance with some embodiments of the present disclosure.

Referring to FIG. 7, a UE may be configured with multiple cells (e.g., including but not limited to cells 701 and 702). It is assumed that for symbols 0-3 of slot #n, cell 701 is determined as the reference cell according to the aforementioned methods or other methods. The UE may further determine how to receive or transmit information in symbols 0-3 on cell 701 and another cell (e.g., cell 702) among the multiple configured cells according to the transmission or reception types of the reference cell and the another cell (e.g., cell 702). In some embodiments, cell 702 is from a set of cells with enabled directional collision handling among the multiple configured cells.

For example, symbols 0-3 on cell 701 are indicated as DL (or DL but not SBFD), the transmission or reception type of cell 701 is Semi-D, and symbols 0-3 on cell 702 are indicated as SBFD (or DL with UL subband or DL with UL frequency domain region), the transmission or reception type of cell 702 is Semi-D with SBFD.

In some embodiments, the UE may: (i) assume symbols 0-3 as flexible; (ii) determine that it is not required to receive a higher layer configured PDCCH, PDSCH, or CSI-RS and not expected to transmit a higher layer configured SRS, PUCCH, PUSCH, or PRACH in symbols 0-3; or a combination of (i) and (ii).

In some embodiments, the UE may assume symbols 0-3 as downlink.

In some embodiments, the UE may: (iii) assume the UL subband/UL frequency domain region in symbols 0-3 on cell 702 as a flexible subband; (iv) determine that it is not expected to transmit a higher layer configured SRS, PUCCH, PUSCH, or PRACH in the UL subband in symbols 0-3; or a combination of (iii) and (iv)

Referring to FIG. 8, a UE may be configured with multiple cells (e.g., including but not limited to cells 801 and 802). It is assumed that for symbols 6-9 of slot #n, cell 801 is determined as the reference cell according to the aforementioned methods or other methods. The UE may further determine how to receive or transmit information in symbols 6-9 on cell 801 and another cell (e.g., cell 802) among the multiple configured cells according to the transmission or reception types of the reference cell and the another cell (e.g., cell 802). In some embodiments, cell 802 is from a set of cells with enabled directional collision handling among the multiple configured cells.

For example, the UE is configured to transmit an SRS, PUCCH, PUSCH, or PRACH on cell 801 in symbols 6-9. The transmission or reception type of cell 801 in symbols 6-9 is Configured U. Symbols 6-9 on cell 802 are indicated as SBFD (or DL with UL subband or DL with UL frequency domain region), the transmission or reception type of cell 802 is Semi-D with SBFD.

In some embodiments, the UE may assume the DL subbands (or DL frequency domain regions) 803 and 804 in symbols 6-9 on cell 802 as flexible subbands (or flexible frequency domain regions). In some embodiments, the UE may assume symbols 6-9 on cell 802 to be flexible. In some embodiments, the UE may determine that it is not required to receive a higher layer configured PDCCH, PDSCH, or CSI-RS in DL subbands (or DL frequency domain regions) 803 and 804.

Referring back to FIG. 5, in some embodiments of the present disclosure, the UE may perform at least one of the following operations before operation 513, i.e., determining how to receive or transmit information on the reference cell and another cell among the multiple cells: determining the transmission or reception type of the symbol on the reference cell; or determining the transmission or reception type of the symbol on the another cell.

In some embodiments, as described above, it is defined that when the symbol format for a symbol on a certain cell is indicated as SBFD (e.g., by a higher layer configuration), this cell cannot be the reference cell for the symbol. In such embodiments, the transmission or reception type of a symbol on the corresponding reference cell is always not “SBFD,” “Semi-D with SBFD,” or “Flexible with SBFD.”

In some embodiments, as described above, it is defined that when the symbol format of a symbol on a certain cell is indicated as SBFD (e.g., by a higher layer configuration), this cell can be a candidate for the reference cell for the symbol.

In some embodiments of the present disclosure, determining the transmission or reception type of the symbol on the reference cell may include determining the transmission or reception type of the symbol on the reference cell as being indicated as UL in the symbol on the reference cell (e.g., Semi-U) in the case that: the symbol is indicated as SBFD on the reference cell; or the symbol is indicated as SBFD on the reference cell and neither a UL transmission nor a DL reception is configured or scheduled to be performed in the symbol on the reference cell.

For example, when the symbol format of a symbol on a corresponding reference cell is indicated as SBFD (e.g., by a higher layer configuration), the transmission or reception type of the symbol on the reference cell may be determined as (e.g., assumed as) “Semi-U.” For example, when the symbol format of a symbol on a corresponding reference cell is indicated as SBFD (e.g., by a higher layer configuration), the UE may further determine whether a UL transmission or a DL reception is configured (e.g., by higher layers such as RRC) or scheduled (e.g., by a DCI format) to be performed in the symbol on the reference cell, and if neither a UL transmission nor a DL reception is to be performed, the transmission or reception type of the symbol on the reference cell may be determined as (e.g., assumed as) “Semi-U.”

Otherwise, if a UL transmission or a DL reception is to be performed, the transmission or reception type of the symbol on the reference cell may be determined according to the priority of the transmission or reception.

In some embodiments of the present disclosure, determining the transmission or reception type of the symbol on the another cell may include determining the transmission or reception type of the symbol on the another cell as being indicated as SBFD in the symbol on the another cell in the case that: the symbol is indicated as SBFD on the another cell; or the symbol is indicated as SBFD on the another cell and neither a UL transmission nor a DL reception is configured or scheduled to be performed in the symbol on the another cell.

For example, when the symbol format of a symbol on the another cell is indicated as SBFD (e.g., by a higher layer configuration), the transmission or reception type of the symbol on the another cell may be determined as “SBFD” or “Semi-D with SBFD.” For example, when the symbol format of a symbol on the another cell is indicated as SBFD (e.g., by a higher layer configuration), the UE may further determine whether a UL transmission or a DL reception is configured (e.g., by higher layers such as RRC) or scheduled (e.g., by a DCI format) to be performed in the symbol on the another cell, and if neither a UL transmission nor a DL reception is to be performed, the transmission or reception type of the symbol on the another cell may be determined as “SBFD” or “Semi-D with SBFD.” Otherwise, if a UL transmission or a DL reception is to be performed, the transmission or reception type of the symbol on the another cell may be determined according to the priority of the transmission or reception.

It should be appreciated by persons skilled in the art that the sequence of the operations in exemplary procedure 500 may be changed and some of the operations in exemplary procedure 500 may be eliminated or modified, without departing from the spirit and scope of the disclosure.

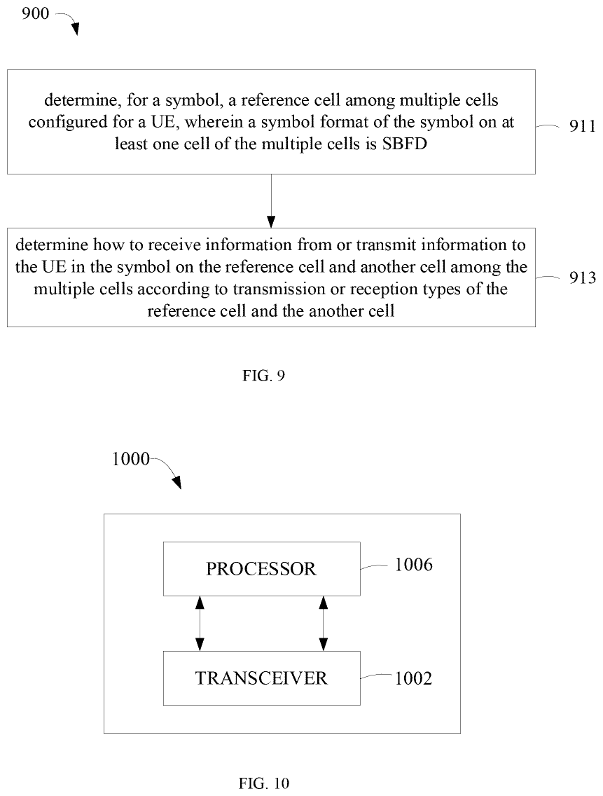

FIG. 9 illustrates a flow chart of an exemplary procedure 900 for determining a resource for a UL transmission in accordance with some embodiments of the present disclosure. Procedure 900 may be implemented by a network entity (e.g., BS 102 as shown in FIG. 1). Details described in all of the foregoing embodiments of the present disclosure are applicable for the embodiments shown in FIG. 9.

Referring to FIG. 9, in operation 911, a BS may determine, for a symbol (e.g., symbol #A), a reference cell among multiple cells configured for a UE, wherein a symbol format of the symbol on at least one cell of the multiple cells is SBFD.

The definition of the term “symbol format” in the foregoing embodiments may apply here. For example, the symbol format of a symbol being SBFD may include at least one of the following: the symbol being indicated as downlink with a UL frequency region or a UL subband; the symbol being indicated as flexible with a UL frequency region or a UL subband; or the symbol being indicated as flexible and a DL reception and a UL reception being configured to be performed in the symbol simultaneously.

The descriptions regarding how to determine the reference cell in the foregoing embodiments may apply here.

For example, in some embodiments of the present disclosure, the reference cell is from a set of cells of the multiple cells, wherein a symbol format of the symbol on each cell of the set of cells is not SBFD. In some embodiments of the present disclosure, a symbol format of the symbol on a cell of the set of cells is: DL but not SBFD or UL as indicated by a higher layer configuration; UL, if the symbol is indicated as flexible but not SBFD, and a UL reception is configured to be performed in the symbol; UL, if the symbol is indicated as flexible and SBFD, a UL reception is configured to be performed in the symbol, and a DL transmission is not configured to be performed in the symbol; DL, if the symbol is indicated as flexible but not SBFD, and a DL transmission is configured to be performed in the symbol; or DL, if the symbol is indicated as flexible and SBFD, a DL transmission is configured to be performed in the symbol, and a UL reception is not configured to be performed in the symbol. In some embodiments of the present disclosure, a symbol format(s) of the symbol on at least one cell of the multiple cells is not SBFD.

For example, in some embodiments of the present disclosure, a symbol format of the symbol on the reference cell is not SBFD. In some embodiments of the present disclosure, the symbol format of the symbol on the reference cell is: DL but not SBFD or UL as indicated by a higher layer configuration; UL, if the symbol is indicated as flexible but not SBFD, and a UL reception is configured to be performed in the symbol; UL, if the symbol is indicated as flexible and SBFD, a UL reception is configured to be performed in the symbol, and a DL transmission is not configured to be performed in the symbol; DL, if the symbol is indicated as flexible but not SBFD, and a DL transmission is configured to be performed in the symbol; or DL, if the symbol is indicated as flexible and SBFD, a DL transmission is configured to be performed in the symbol, and a UL reception is not configured to be performed in the symbol. In some embodiments of the present disclosure, a symbol format(s) of the symbol on at least one cell of the multiple cells is not SBFD.

For example, in some embodiments of the present disclosure, the symbol format of the symbol on the reference cell of the multiple cells is: SBFD, if the symbol is indicated as SBFD by a higher layer configuration; UL, if the symbol is indicated as SBFD by a higher layer configuration; UL, if the symbol is indicated as flexible and SBFD, a UL reception is configured to be performed in the symbol, and a DL transmission is not configured to be performed in the symbol; or DL, if the symbol is indicated as flexible and SBFD, and a DL transmission is configured to be performed in the symbol, and a UL reception is not configured to be performed in the symbol.

In operation 913, the BS may determine how to receive information from or transmit information to the UE in the symbol (e.g., symbol #A) on the reference cell and another cell among the multiple cells according to transmission or reception types of the reference cell and the another cell.

The descriptions regarding the another cell in the foregoing embodiments may apply here. The definition of the term “transmission or reception type” in the foregoing embodiments may apply here. The descriptions regarding how to receive or transmit information in a symbol with respect to operation 513 may be similarly applied here.

For example, in some embodiments of the present disclosure, the BS may prohibit at least one of the following in the case that the another cell operates in the same frequency band as the reference cell: indicating the symbol format of the symbol as DL on the reference cell and as SBFD on the another cell; or indicating the symbol format of the symbol as UL on the reference cell and as SBFD on the another cell.

For example, in some embodiments of the present disclosure, determining how to receive information from or transmit information to the UE on the reference cell and another cell comprises: assuming the symbol as flexible, when the symbol is indicated as SBFD on the another cell and as UL or DL on the reference cell, or when the symbol is indicated as SBFD on the another cell and one of: a UL reception is configured to be performed in the symbol on the reference cell and a DL transmission is configured to be performed in the symbol on the reference cell; assuming the symbol as DL, when the symbol is indicated as SBFD on the another cell and as DL on the reference cell, or when the symbol is indicated as SBFD on the another cell and a DL transmission is configured to be performed in the symbol on the reference cell; assuming a DL or UL frequency domain region in the symbol on the another cell as a flexible frequency domain region, when the symbol is indicated as SBFD on the another cell and as UL or DL on the reference cell, or when the symbol is indicated as SBFD on the another cell and one of: a UL reception is configured to be performed in the symbol on the reference cell and a DL transmission is configured to be performed in the symbol on the reference cell; or not transmitting configured data to the UE in the symbol or in a DL frequency domain region in the symbol on the another cell, or not receiving configured data from the UE in the symbol or in a UL frequency domain region in the symbol on the another cell, when the symbol is indicated as SBFD on the another cell and as UL or DL on the reference cell, or when the symbol is indicated as SBFD on the another cell and one of: a UL reception is configured to be performed in the symbol on the reference cell and a DL transmission is configured to be performed in the symbol on the reference cell.

in some embodiments of the present disclosure, the BS may perform at least one of the following operations before operation 913, i.e., determining how to receive information from or transmit information to the UE on the reference cell and another cell: determining the transmission or reception type of the symbol on the reference cell; or determining the transmission or reception type of the symbol on the another cell.

In some embodiments of the present disclosure, determining the transmission or reception type of the symbol on the reference cell comprises determining the transmission or reception type of the symbol on the reference cell as being indicated as UL in the symbol on the reference cell in the case that: the symbol is indicated as SBFD on the reference cell; or the symbol is indicated as SBFD on the reference cell and neither a UL reception nor a DL reception is configured or scheduled to be performed in the symbol on the reference cell.

In some embodiments of the present disclosure, determining the transmission or reception type of the symbol on the another cell comprises determining the transmission or reception type of the symbol on the another cell as being indicated as SBFD in the symbol on the another cell in the case that: the symbol is indicated as SBFD on the another cell; or the symbol is indicated as SBFD on the another cell and neither a UL reception nor a DL reception is configured or scheduled to be performed in the symbol on the another cell.

It should be appreciated by persons skilled in the art that the sequence of the operations in exemplary procedure 900 may be changed and some of the operations in exemplary procedure 900 may be eliminated or modified, without departing from the spirit and scope of the disclosure.

FIG. 10 illustrates a block diagram of an exemplary apparatus 1000 according to some embodiments of the present disclosure. As shown in FIG. 10, the apparatus 1000 may include at least one processor 1006 and at least one transceiver 1002 coupled to the processor 1006. The apparatus 1000 may be a UE or a network entity such as a BS.

Although in this figure, elements such as the at least one transceiver 1002 and processor 1006 are described in the singular, the plural is contemplated unless a limitation to the singular is explicitly stated. In some embodiments of the present application, the transceiver 1002 may be divided into two devices, such as a receiving circuitry and a transmitting circuitry. In some embodiments of the present application, the apparatus 1000 may further include an input device, a memory, and/or other components.

In some embodiments of the present application, the apparatus 1000 may be a UE. The transceiver 1002 and the processor 1006 may interact with each other so as to perform the operations with respect to the UE described in FIGS. 1-9. In some embodiments of the present application, the apparatus 1000 may be a BS. The transceiver 1002 and the processor 1006 may interact with each other so as to perform the operations with respect to the BS described in FIGS. 1-9.

In some embodiments of the present application, the apparatus 1000 may further include at least one non-transitory computer-readable medium.

For example, in some embodiments of the present disclosure, the non-transitory computer-readable medium may have stored thereon computer-executable instructions to cause the processor 1006 to implement the method with respect to the UE as described above. For example, the computer-executable instructions, when executed, cause the processor 1006 interacting with transceiver 1002 to perform the operations with respect to the UE described in FIGS. 1-9.

In some embodiments of the present disclosure, the non-transitory computer-readable medium may have stored thereon computer-executable instructions to cause the processor 1006 to implement the method with respect to the BS as described above. For example, the computer-executable instructions, when executed, cause the processor 1006 interacting with transceiver 1002 to perform the operations with respect to the BS described in FIGS. 1-9.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
determine, for a symbol, a reference cell among multiple cells, wherein a symbol format of the symbol on at least one cell of the multiple cells is subband non-overlapping full duplex (SBFD); and
determine how to receive or transmit information in the symbol on the reference cell and another cell among the multiple cells, according to transmission or reception types of the reference cell and the another cell.

2. The UE of claim 1, wherein a symbol format of the symbol on the reference cell is not SBFD.

3. The UE of claim 2, wherein the symbol format of the symbol on the reference cell is:
downlink (DL), but not SBFD or uplink (UL), as indicated by a higher layer configuration;
UL, if the symbol is indicated as flexible, but not SBFD, and a UL transmission is configured to be performed in the symbol;
UL, if the symbol is indicated as flexible, and SBFD, and a UL transmission is configured to be performed in the symbol and a DL reception is not configured to be performed in the symbol;
DL, if the symbol is indicated as flexible, but not SBFD, and a DL reception is configured to be performed in the symbol; or
DL, if the symbol is indicated as flexible, and SBFD, and a DL reception is configured to be performed in the symbol, and a UL transmission is not configured to be performed in the symbol.

4. The UE of claim 1, wherein the reference cell is from a set of cells of the multiple cells, wherein a symbol format of the symbol on each cell of the set of cells is not SBFD.

5. The UE of claim 4, wherein a symbol format of the symbol on a cell of the set of cells is:
downlink (DL), but not SBFD or uplink (UL), as indicated by a higher layer configuration;
UL, if the symbol is indicated as flexible, but not SBFD, and a UL transmission is configured to be performed in the symbol;
UL, if the symbol is indicated as flexible, and SBFD, and a UL transmission is configured to be performed in the symbol and a DL reception is not configured to be performed in the symbol;
DL, if the symbol is indicated as flexible, but not SBFD, and a DL reception is configured to be performed in the symbol; or
DL, if the symbol is indicated as flexible, and SBFD, and a DL reception is configured to be performed in the symbol, and a UL transmission is not configured to be performed in the symbol.

6. The UE of claim 4, wherein a symbol format(s) format of the symbol on at least one cell of the multiple cells is not SBFD.

7. The UE of claim 1, wherein the symbol format of the symbol on the reference cell of the multiple cells is:
SBFD, if the symbol is indicated as SBFD by a higher layer configuration;
uplink (UL), if the symbol is indicated as SBFD by a higher layer configuration;
UL, if the symbol is indicated as flexible, and SBFD, and a UL transmission is configured to be performed in the symbol and a DL reception is not configured to be performed in the symbol; or
downlink (DL), if the symbol is indicated as flexible, and SBFD, and a DL reception is configured to be performed in the symbol, and a UL transmission is not configured to be performed in the symbol.

8. The UE of claim 1, wherein, when the another cell operates in the same frequency band as the reference cell, the UE does not expect at least one of the following:
the symbol format of the symbol to be indicated as downlink (DL) on the reference cell and as SBFD on the another cell; or
the symbol format of the symbol to be indicated as uplink (UL) on the reference cell and as SBFD on the another cell.

9. The UE of claim 1, wherein, to determine how to receive or transmit information on the reference cell and another cell among the multiple cells, according to transmission or reception types of the reference cell and another cell, the at least one processor is configured to cause the UE to:
assume the symbol as flexible, when the symbol is indicated as SBFD on the another cell and as uplink (UL) or downlink (DL) on the reference cell, or when the symbol is indicated as SBFD on the another cell and one of: a UL transmission is configured to be performed in the symbol on the reference cell and a DL reception is configured to be performed in the symbol on the reference cell;
assume the symbol as DL, when the symbol is indicated as SBFD on the another cell and as DL on the reference cell, or when the symbol is indicated as SBFD on the another cell and a DL reception is configured to be performed in the symbol on the reference cell;
assume a DL or UL frequency domain region in the symbol on the another cell as a flexible frequency domain region, when the symbol is indicated as SBFD on the another cell and as UL or DL on the reference cell, or when the symbol is indicated as SBFD on the another cell and one of: a UL transmission is configured to be performed in the symbol on the reference cell and a DL reception is configured to be performed in the symbol on the reference cell; or
determine to not receive configured data in the symbol or in a DL frequency domain region in the symbol on the another cell, or not expect to transmit configured data in the symbol or in a UL frequency domain region in the symbol on the another cell, when the symbol is indicated as SBFD on the another cell and as UL or DL on the reference cell, or when the symbol is indicated as SBFD on the another cell and one of: a UL transmission is configured to be performed in the symbol on the reference cell and a DL reception is configured to be performed in the symbol on the reference cell.

10. The UE of claim 1, wherein the at least processor is further configured to cause the UE to: before determining how to receive or transmit information on the reference cell and another cell among the multiple cells, according to transmission or reception types of the reference cell and another cell:
determine the transmission or reception type of the symbol on the reference cell; or
determine the transmission or reception type of the symbol on the another cell.

11. The UE of claim 10, wherein, to determine the transmission or reception type of the symbol on the reference cell, the at least one processor is configured to cause the UE to: determine the transmission or reception type of the symbol on the reference cell as being indicated as uplink (UL) in the symbol on the reference cell when:
the symbol is indicated as SBFD on the reference cell; or
the symbol is indicated as SBFD on the reference cell and neither a UL transmission nor a downlink (DL) reception is configured or scheduled to be performed in the symbol on the reference cell.

12. The UE of claim 10, wherein, to determine the transmission or reception type of the symbol on the another cell, the at least one processor is configured to cause the UE to: determine the transmission or reception type of the symbol on the another cell as being indicated as SBFD in the symbol on the another cell when:
the symbol is indicated as SBFD on the another cell; or
the symbol is indicated as SBFD on the another cell and neither a uplink (UL) transmission nor a downlink (DL) reception is configured or scheduled to be performed in the symbol on the another cell.

13. The UE of claim 1, wherein the symbol format of a symbol being SBFD includes:
the symbol being indicated as downlink with an uplink (UL) frequency region or a UL subband;
the symbol being indicated as flexible with a UL frequency region or a UL subband; or
the symbol being indicated as flexible and a downlink (DL) reception and a UL transmission being configured to be performed in the symbol simultaneously.

14. A base station (BS) for wireless communication, comprising:
at least one memory; and
at least one processor coupled with the at least one memory and configured to cause the BS to:
determine, for a symbol, a reference cell among multiple cells configured for a user equipment (UE), wherein a symbol format of the symbol on at least one cell of the multiple cells is subband non-overlapping full duplex (SBFD); and
determine how to receive information from or transmit information to the UE in the symbol on the reference cell and another cell among the multiple cells according to transmission or reception types of the reference cell and the another cell.

15. A method performed by a user equipment (UE), the method comprising:
determining, for a symbol, a reference cell among multiple cells, wherein a symbol format of the symbol on at least one cell of the multiple cells is subband non-overlapping full duplex (SBFD); and
determining how to receive or transmit information in the symbol on the reference cell and another cell among the multiple cells according to transmission or reception types of the reference cell and the another cell.

16. The method of claim 15, wherein a symbol format of the symbol on the reference cell is not SBFD.

17. The method of claim 15, wherein the reference cell is from a set of cells of the multiple cells, wherein a symbol format of the symbol on each cell of the set of cells is not SBFD.

18. The method of claim 15, wherein the symbol format of the symbol on the reference cell of the multiple cells is:
SBFD, if the symbol is indicated as SBFD by a higher layer configuration;
uplink (UL), if the symbol is indicated as SBFD by a higher layer configuration;
UL, if the symbol is indicated as flexible, and SBFD, and a UL transmission is configured to be performed in the symbol and a DL reception is not configured to be performed in the symbol; or
downlink (DL), if the symbol is indicated as flexible, and SBFD, and a DL reception is configured to be performed in the symbol, and a UL transmission is not configured to be performed in the symbol.

19. The method of claim 15, wherein the symbol format of a symbol being SBFD includes:
the symbol being indicated as downlink with an uplink (UL) frequency region or a UL subband;
the symbol being indicated as flexible with a UL frequency region or a UL subband; or
the symbol being indicated as flexible and a downlink (DL) reception and a UL transmission being configured to be performed in the symbol simultaneously.

20. A method performed by a base station (BS), the method comprising:
determining, for a symbol, a reference cell among multiple cells configured for a user equipment (UE), wherein a symbol format of the symbol on at least one cell of the multiple cells is subband non-overlapping full duplex (SBFD); and
determining how to receive information from or transmit information to the UE in the symbol on the reference cell and another cell among the multiple cells according to transmission or reception types of the reference cell and the another cell.
